(19) United States
(12) Patent Application Publication
(10) Pub. No.: US 2008/0224833 A1
(43) Pub. Date: Sep. 18, 2008

(54) IC MEMORY, INFORMATION COMMUNICATION APPARATUS, AND INFORMATION MANAGEMENT SYSTEM

(76) Inventors: Makoto Aikawa, Sagamihara (JP); Shinichiro Fukushima, Yokohama (JP); Masumi Moritani, Yokohama (JP); Hiroyuki Higaki, Yokohama (JP); Yuichi Kobayashi, Yokohama (JP); Atsushi Honzawa, Kawasaki (JP); Akira Kishida, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/031,915

(22) Filed: Feb. 15, 2008

(30) Foreign Application Priority Data
Mar. 16, 2007 (JP) 2007-068967

(51) Int. Cl. H04Q 5/22

(52) U.S. Cl. 340/10.51

(57) ABSTRACT

An information management system comprises information processing unit 51 which reads out self ID number data and reference ID number data from each RFID tag, and additionally writes all the self ID number data and reference ID number data into an ID table. The data in each row of the ID table is the self ID number data and reference ID number data that are stored in each RFID tag. “0” is set to all rows of a link flag setting region, and it is checked whether a value in the M-th row of the reference ID number data is equal to a value in the N-th row of the self ID number data. If both are equal, then “1” is set to the N-th row in the link flag setting region. These processing operations are repeated for all rows of the ID table.

### INCORPORATION BY REFERENCE

The present application claims priority from Japanese application JP2007-068967 filed on Mar. 16, 2007, the content of which is hereby incorporated by reference into this application.

### BACKGROUND OF THE INVENTION

The present invention relates to an IC memory, such as one represented by an RFID (Radio Frequency Identification) tag, which has a plurality of memory portions, an information communication apparatus for communicating with the IC memory, and an information management system comprising the IC memory and information communication apparatus.

Conventionally, an article management system employing the RFID tag has been proposed that aims to make it possible to accurately know whether all tags can be read even if information on a total number of the tags is not provided. According to the proposition, the article management system comprises a plurality of RFID tags that are each attached to an article, an RFID reader/writer apparatus for reading and writing data from and to the RFID tags, and a personal computer for connecting to the RFID reader/writer apparatus via a communication network to control the RFID reader/writer apparatus. The RFID reader/writer apparatus comprises an antenna for transmitting and receiving an electric wave to and from the RFID tags, and an antenna cable for connecting the antenna to the RFID reader/writer apparatus. Relevant information, which indicates the relationship with other RFID tags and is simultaneously read out by the RFID reader/writer apparatus, is written in each RFID tag (e.g., JP-A-2002-92114).

### SUMMARY OF THE INVENTION

However, in the above-configured conventional article management system, there sometimes arises a case in which the RFID reader/writer apparatus cannot write and read data to and from the tags. For example, in article distribution equipment equipped with the article management system, when a plurality of articles, each attached with the RFID tag, are loaded on a cargo-handling stage in disorder, the RFID reader/writer apparatus cannot write and read data to and from the tags due to a relationship between the positions of the articles attached with the RFID tags and the position where the RFID reader/writer apparatus is disposed.

If there are RFID tags from or into which the RFID reader/writer apparatus cannot read or write data, it becomes impossible to manage the articles placed on the cargo-handling stage, in their entirety. Besides, when some articles are extracted from the plurality of articles that are placed on the cargo-handling stage, some articles are replaced by other ones, or other articles are added, it would not only be difficult to identify which articles are involved in the cases, but also impossible to even know that those cases took place.

Therefore, it is an object of the present invention to enable the information management system, which comprises IC memories and an information communication apparatus for performing information communication with the IC memories, to readily read or read to identify all information written in the IC memories that are each mounted on each of a number of articles.

It is another object of the present invention to enable the information management system, which comprises the IC memories and information communication apparatus for performing information communication with the IC memories, to also manage packaged finished products as well as parts thereof in a case where the packaged finished products as well as parts thereof are to be managed.

The IC memory according to a first aspect of the present invention has an information transmission/reception capability and an information processing capability, and transmits and receives information to and from an external information communication apparatus. The IC memory stores, first identification data for identifying that IC memory, the first identification data being required by a plurality of IC memories to form links between the IC memories themselves on the data, and second identification data for identifying an IC memory other than that IC memory, in a memory portion thereof.

In a preferred embodiment according to the first aspect of the present invention, the first and second identification data are written into the above memory portion by the above external information communication apparatus.

In an embodiment different from the embodiment described above, at least two or more pieces of the above identification data are stored in the memory portion.

The information communication apparatus according to a second aspect of the present invention has an information processing capability, and transmits and receives information to and from an IC memory that has an information transmission/reception capability as well as an information processing capability. The information communication apparatus stores comprehensive IC memory identifying data that includes at least first identification data for identifying a certain IC memory, the first identification data being required by a plurality of IC memories to form links between the IC memories themselves on data, and second identification data for identifying an IC memory other than the certain IC memory, in a storage unit thereof.

In a preferred embodiment according to the second aspect of the present invention, the above comprehensive IC memory identifying data is generated based on the first and second identifying data that are transmitted from the above IC memories.

In an embodiment different from the one described above, the above comprehensive IC memory identifying data includes at least two or more pieces of the above second identification data.

In an embodiment different the one described above, the above comprehensive IC memory identifying data further includes flag data that indicates whether a link is actually formed in the data.

In addition, in an embodiment different the one described above, the above flag data is set to a value that indicates that the above link is not formed during generation of the above comprehensive IC memory identifying data.

The information management system according to a third aspect of the present invention comprises IC memories that have an information transmission/reception capability and an information processing capability, and one or a plurality of information processing apparatuses that have an information processing capability and transmits and receives information to and from the above IC memories. The above IC memories store first identification data for identifying that IC memory, the first identification data being required by a plurality of IC memories to form links between the IC memories themselves on the data, and second data for identifying an IC memory other than that IC memory, in a memory portion thereof. The above information communication apparatus stores comprehensive IC memory identifying data that includes at least first identification data for identifying a certain IC memory, the certain identification data being required by a plurality of memories to form links between the IC memories themselves on the data, and second identification data for identifying an IC memory other than the certain IC memory, in a storage unit thereof.

In a preferred embodiment according to the third aspect of the present invention, the above information management system comprises a placement stage for placing articles thereon, and is applied to an operation device that is required when sending the articles placed on the placement stage in a distribution process.

In an embodiment different from the one described above, the above information communication apparatus is disposed in such a way that a transmission/reception unit thereof faces the above placement stage, the above IC memory is mounted on an area of the placement stage that faces the above transmission/reception unit, and the above IC memory is also mounted on an appropriate place of the article loaded on the above placement stage.

In an embodiment different from the one described above, the IC memory mounted on the above placement stage stores: first identification data for identifying that IC memory, which is required by a plurality of IC memories to form links between the IC memories themselves on the data; second identification data for identifying IC memories that are different from the foregoing IC memory and are mounted on any of the articles loaded on the above placement stage; data indicating whether the above link, in its entirety, forms a circulation structure; multiplicity data indicating how many of above links are formed between that IC memory and a plurality of IC memories that are different from that IC memory and are mounted on a plurality of articles loaded on the placement stage; data indicating a total number of the IC memories attached to each of the above articles; at least the above first and second identification data of update link information for indicating a change in the above link; and data indicating whether above links, in their entirety, form a circulation structure.

Moreover, in an embodiment different from the one described above, each of the comprehensive IC memory identifying data stored by the above information communication apparatus includes at least two or more pieces of the above second identification data.

In an embodiment different from the one described above, it is configured that when an article is additionally loaded on the placement stage, and thereby a communication is established between the above information communication apparatus and a new IC memory mounted on the additional article, the new IC memory is caused to store data for identifying the IC memory mounted on the placement stage, and the IC memory mounted on the placement stage is caused to store the data for identifying the new IC memory.

In an embodiment different from the one described above, it is configure that when any of the plurality of articles loaded on the above placement stage is removed, resulting in loss of communication between the above information communication apparatus and the IC memory of the removed article, the IC memory of the above placement stage is caused to store the first identification data for identifying the IC memory of the removed article, and second identification data, which is stored in the IC memory, for identifying a different IC memory that formed a link with the IC memory on data, and the IC memory of another article that stored the above first identifying data is caused to store the above second identifying data. Then, the above first and second identification data that were stored are configured to be erased from the IC memory of the above placement stage.

Furthermore, in an embodiment different from the one described above, when a communication is lost between the above information communication apparatus and the IC memory of the article that is removed from the above placement stage, data related to the above circulation structure, which is stored in the IC memory of the above placement stage, is changed to unsuccessful circulation. After the above processing of the IC memory of the above placement stage and IC memory of another article on the above placement stage is terminated, the data related to the above circulation structure is changed to successful circulation.

The present invention enables the information management system, which comprises IC memories and an information communication apparatus for performing information communication with the IC memories, to readily read or read to identify all information written in each IC memory mounted on each of a number of articles.

Moreover, when packaged finished products as well as parts thereof are to be managed, the present invention enables the information management system that comprises the IC memory and information communication apparatus for performing information communication with the IC memory to manage the packaged finished products as well as the parts thereof.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an entire configuration of an information management system according one embodiment of the present invention;

FIG. 2 is an explanatory diagram showing an exemplary internal configuration of an ID table set in an information storage unit of an RFID reader/writer apparatus shown in FIG. 1;

FIG. 3 is an explanatory diagram showing an example of a reading sequence of self ID number data and reference ID number data that are stored in (a memory circuit of) an RFID tag, which is performed by the RFID reader/writer apparatus shown in FIG. 1;

FIG. 4 is an explanatory diagram showing an another example of a reading sequence of the self ID number data and reference ID number data that are stored in (the memory circuit of) the RFID tag, which is performed by the RFID reader/writer apparatus shown in FIG. 1;

FIG. 5 is a an explanatory diagram showing an example of the variation of the RFID tags that are used in the information management system according to one embodiment of the present invention;

FIG. 6 is a an explanatory diagram showing an example of the internal configuration of an ID table that is set in an information storage unit of the RFID reader/writer apparatus, which is used for communication with the RFID tags illustrated in FIG. 5;

FIG. 7 is a an explanatory diagram showing an example of a reading sequence of unique ID number data (stored in the memory circuit of the RFID tag) when the RFID tags shown in FIG. 5 are used in an information management system according to one embodiment of the present invention;

FIGS. 8A and 8B are explanatory diagrams showing an example of various kinds of devices required for a distribution process, such as handling, transporting and storing of articles in which the RFID tag according to one embodiment of the present invention is employed;

FIGS. 9A and 9B are explanatory diagrams showing an example of a package of an industrial product (finished product), which is finished as an article in which the RFID tag according to one embodiment of the present invention is employed, and attachments that are used together with the finished product;

FIG. 10 is an explanatory diagram showing another example of various kinds of devices required for the distribution process, such as handling, transporting, and storing of articles in which the RFID tags according to one embodiment of the present invention is employed;

FIGS. 11A and 11B are explanatory diagrams showing a configuration of a multiple link formed between a package tag and individual article tags, and between the individual article tags themselves via the self ID number data and reference ID number data that are stored in (the memory circuit of) the package tag, and the self ID number data and reference ID number data that are stored in each of (the memory circuits of) a plurality of the individual tags;

FIGS. 12A and 12B are schematic diagrams showing a process in which, when an individual article is additionally loaded on the pallet in the aspect shown in FIG. 10, links are formed between an individual article tag of the individual article that is additionally loaded, and the existing package tag and individual article tags via the self ID number data and reference ID number data that are stored in (the memory circuit of) each tag;

FIG. 13 is a flow chart showing a processing procedure when links are formed, through the additional loading of the new individual article on the pallet, between the individual article tag of the new individual article and the existing package tag and individual article tags via the self ID number data and reference ID number data that are stored in (the memory circuit of) each tag;

FIGS. 14A and 14B are schematic diagrams showing a process in which, when any individual article is removed from the individual articles that are previously loaded on the pallet in the aspect shown in FIG. 10, links are formed between individual article tags themselves of remaining individual articles, and between those individual tags and package tag via the self ID number data and reference ID number data that are stored in (the memory circuit of) each tag; and

FIG. 15 is a flow chart showing a processing procedure in which, when any of the individual articles is removed from the pallet, links are formed between the individual article tags themselves of the remaining individual articles, and between those individual article tags and package tag via the self ID number data and reference ID number data that are stored in (the memory circuit of) each tag.

### DESCRIPTION OF EMBODIMENTS

Hereinafter, embodiments of the present invention will be described in detail with reference to appended drawings.

The scope of the present invention covers not only the RFID tags but also other kinds of IC memories. However, in the following sections, aspects in which the present invention is applied to the RFID tags will be described as embodiments of the present invention with reference to the appended drawings. Therefore, even if the following description relates only to the RFID tags, this should not be construed as to mean that the scope of the present invention does not cover other kinds of IC memories.

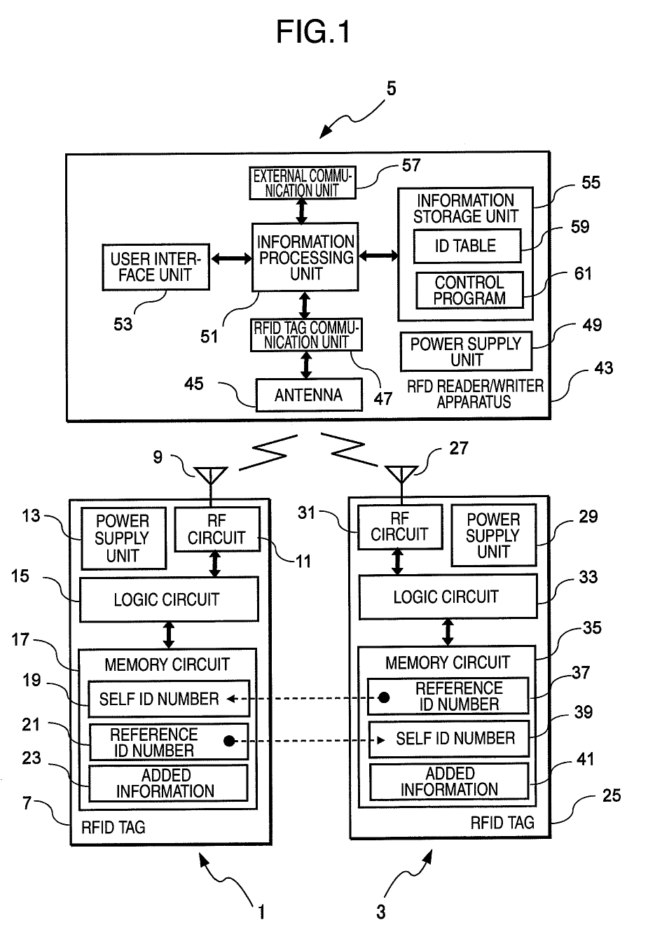

FIG. 1 is a block diagram showing an entire configuration of an information management system according to one embodiment of the present invention.

As FIG. 1 shows, the information management system comprises a plurality of RFID tags 1, 3 (only two tags are shown in FIG. 1 for the sake of illustration), and one or more information communication apparatuses, or RFID reader/writer apparatus 5 (only one apparatus is shown in FIG. 1 for the sake of illustration and description). The RFID reader/writer apparatus 5 serves as an external communication apparatus that transmits and receives information to and from the RFID tags 1, 3 over wireless communication.

Data is configured to be written into the RFID tags 1, 3 by, for example, the RFID reader/writer 5, and the written data is configured to be read by an RFID reader/writer apparatus (different from the RFID reader/writer apparatus 5) or the RFID reader/writer apparatus 5.

As FIG. 1 shows, the RFID tag 1 comprises an RFID body 7; an antenna 9 that is mounted on an appropriate place external to the RFID tag body 7; an RF circuit 11 embedded in the RFID tag body 7; a power supply unit 13; a logic circuit 15; and a memory circuit 17. The antenna 9 receives an electric wave (e.g., UHF-band electric wave) that is transmitted from the RFID reader/writer apparatus 5 which serves as an external communication device, outputs the electric wave to the RF circuit 11, and transmits (UH-band) the electric wave outputted from the RF circuit 11 to the RFID reader/writer apparatus 5.

The RF circuit 11 demodulates the above (UHF-band) electric wave, which is a modulated wave, from the antenna 9 under the management of the logic circuit 15 to thereby take out a modulated signal (signal representing various kinds of information) from the electric wave for outputting to the logic circuit 15. The RF circuit 11 also modulates a (UHF-band) carrier wave by a signal representing various kinds of information that is outputted from the logic circuit 15 under the management of the logic circuit 15, and transmits a (UHF-band) electric wave generated by the modulation to the RFID reader/writer apparatus 5 through the antenna 9. The power supply unit 13 generates power by means of electromagnetic induction caused by the above (UHF-band) electric wave that is inputted from the antenna 9 to the RF circuit 11, and supplies the generated power to each part of the RFID tab body 7 as a drive power.

The memory circuit 17 stores various data such as, for example, self ID number data 19, reference ID number data 21, and additional information 23 (e.g., data arbitrarily produced by a user) that are written by the logic circuit 15, under the management of the logic circuit 15. The memory circuit 17 also outputs requested data to the logic circuit 15 in response to a data read-out request from the logic circuit 15 under the management of the logic circuit 15.

The logic circuit 15 performs predetermined protocol processing. In other words, the logic circuit 15 writes command, data and the like, which are represented by the modulated signal (from the RFID reader/writer apparatus 5) that is outputted from the RF circuit 11 and, into a plurality of memory banks (i.e., memory circuit 17). The logic circuit 15 also reads out the data (self ID number data 19, reference ID number data 21, and additional information 23) and the like that are stored in a plurality of above memory banks, and outputs the read data and the like to the RF circuit 11 in order to transmit them to the RFID reader/writer apparatus 5. The logic circuit 15 manages an internal state of the RFID tag body 7 by placing the RF circuit 11 and memory circuit 17 under the management of the logic circuit 15 as described above. It should be noted that the management of the internal state of the RFID tag body 7 includes the management of a lock state such as the advisability of rewriting the memory circuit 17 by a logical management approach using a state management flag.

As is the case with the RFID tag 1, the RFID tag 3 also comprises an RFID body 25; an antenna 27 that is mounted on an appropriate place external to the RFID tag body 25; a power supply unit 29 embedded in the RFID tag body 25; an RF circuit 31; a logic circuit 33; and a memory circuit 35. Detailed description of the RFID tag body 25, antenna 27, power supply unit 29, RF circuit 31, logic circuit 33, and memory circuit 35 is omitted. It should be noted that reference ID number data 37, self ID number data 39, and additional information 41 are also stored in the memory circuit 35, as is the case with the memory circuit 17.

It should be noted that in the present embodiment, as is clear from the reference to FIG. 1, the self ID number data 19 that is stored in the memory circuit 17 of the RFID tag 1 side is stored in the memory circuit 35 of the RFID tag 3 side as the reference ID number data 37. Similarly, the self ID number data 39 that is stored in the memory circuit 35 of the RFID tag 3 side is stored in the memory circuit 17 of the RFID tag 1 side as the reference ID number data 21.

As FIG. 1 shows, the RFID reader/writer apparatus 5 comprises an RFID reader/writer apparatus body 43; an antenna 45 that is embedded in the RFID reader/writer apparatus body 43; an RFID tag communication unit 47; a power supply unit 49; an information processing unit 51; a user interface (I/F) unit 53; an information storage unit 55; and an external communication unit 57. The antenna 45 receives an electric wave (e.g., UHF-band electric wave) transmitted from the FRID tag 1 (or the RFID tag 3) for outputting to the RFID tag communication unit 47, and transmits a (UHF-band) electric wave outputted from the RFID tag communication unit 47 to the RFID tag 1 (or the RFID tag 3).

The RFID tag communication unit 47 demodulates the above (UHF-band) electric wave, which is a modulated wave, from the antenna 45 under the management of the information processing unit 51, and thereby takes out a modulated signal (signal representing various kinds of information) from the electric wave and outputs it to the information processing unit 51. The RFID tag communication unit 47 also modulates a (UHF-band) carrier wave by a signal representing various kinds of information that is outputted from the information processing unit 51, and transmits the (UHF-band) electric wave generated by the modulation to the RFID tag 1 (or the RFID tag 3) through the antenna 45 under the management of the information management unit 51.

The user I/F unit 53 is connected to, for example, an operation unit (not shown), a display unit (not shown), and the like that are mounted on appropriate places of the RFID reader/writer apparatus body 43, and outputs various kinds of data, information, and the like that are inputted by a user via the operation unit (not shown) to the information processing unit 51. The user I/F unit 53 also inputs various kinds of data, information, and the like that are outputted from the information processing unit 51, and outputs them for displaying on the display unit (not shown) in order to inform the user.

The external communication unit 57 operates as a communication interface to an external management apparatus (not shown) that is required to operate the RFID reader/writer apparatus 5 in cooperation, for example, with the external management apparatus (not shown) under the management of the information processing device 51. The power supply unit 49 operates as a direct current stabilizing power source for supplying stabilized direct current to each part that constitutes the RFID reader/writer apparatus 5 to ensure that each portion operates in an appropriate manner.

In the information storage unit 55, an ID table 59 is set, and a control program 61 is embedded. In the ID table 59, for example, the self ID number data (shown by a reference numeral 19 in the RFID tag 1 side, and by a reference numeral 39 in the RFID tag 3 side), and reference ID number data (shown by a reference numeral 21 in the RFID tag 1 side, and by a reference numeral 37 in the RFID tag 3 side) are written by the information processing unit 51. The control program 61 is a program in which a calculation processing operation for the information processing unit 51 is defined. The information storage unit 55 outputs the above requested data to the information processing unit 51 in response to a data read-out request from the information processing unit 51 under the management of the information processing unit 51.

The information processing unit 51 performs predetermined protocol processing. In other words, the information processing unit 51 writes a command, data, and the like represented by a modulation signal (from the RFID tag 1 or RFID tag 3), which is outputted from the RFID tag communication unit 47, into the above table 59 of the information storage unit 55. The information processing unit 51 also reads out the command, data, and the like stored in the above ID table 59 and outputs the read out data, and the like to the RFID tag communication unit 47 in order to transmit it to the RFID tag 1 (or RFID tag 3). As described above, the information processing unit 51 manages an internal state of the RFID reader/writer apparatus body 43 by placing the RFID tag communication unit 47, user I/F unit 53, external communication unit 57, and information storage unit 55 under the management of the information processing unit 51.

It should be noted that while only two RFID tags, 1 and 3, and only one RFID reader/writer apparatus 5 are illustrated in FIG. 1, as described above, this is for the sake of illustration and description. In an actual system, the number of the RFID tags and RFID reader/writer apparatuses is not limited to the above. A number of RFID tags may exist or two or more RFID reader/writer apparatuses may be provided.

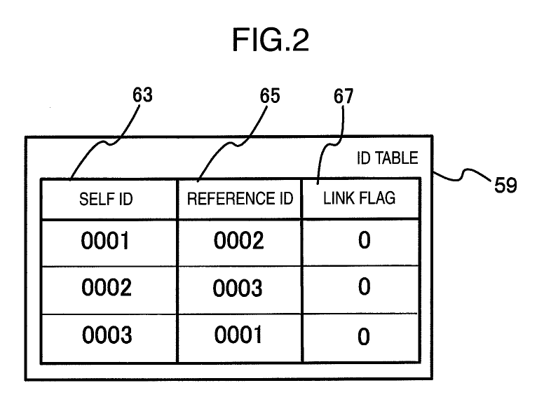

FIG. 2 is an explanatory diagram showing an example of an internal configuration of the ID table 59 set in the information storage unit 55 of the RFID reader/writer apparatus 5.

As FIG. 2 shows, the ID table 59 has a self ID number data storage region 63, a reference ID number data storage region 65, and a link flag setting region 67. In the self ID number data storage region 63 and reference ID number data storage region 65, self ID numbers (ID assigned by a manufacturer during the production of the RFID tags) are stored. The self ID numbers serve as data for identifying the RFID tags that communicated with the RFID reader/writer apparatus 5. In the example shown in FIG. 2, it is evident that there is a link between an RFID tag with a self ID number of “0001” and an RFID tag with a self ID number of “0002”, a link between the RFID tag with the self ID number of “0002” and an RFID tag with a self ID number of “0003”, and a link between the RFID tag with the self ID number of “0003” and the RFID tag with the self ID number of RFID tag “0001”. In the example shown in FIG. 2, “0” is set in any part of the link flag setting region 67 that corresponds to each part of the self ID number ID storage region and reference ID number data storage region.

Next, description will be made on the processing operations performed by the information processing unit 51 shown in FIG. 1 based on the control program 61.

The information processing unit 51 communicates with the RFID tag 1 through the RFID tag communication unit 47 and antenna 45 to thereby read out the self ID number data 19 and reference ID number data 21 stored in the memory circuit 17 of the RFID tag 1 via the logic circuit 15, RF circuit 11, and antenna 9. The information processing unit 51 also communicates with the RFID tag 3 through the RFID tag communication unit 47, and antenna 45 to thereby read out the self ID number data 39 and reference ID number data 37 stored in the memory circuit 35 of the RFID tag 3 via the logic circuit 33, RF circuit 31, and antenna 27.

In the above aspect, the information processing unit 51 reads out the self ID number data and reference ID number data from each RFID tag, and additionally writes all the read out self ID number data and reference ID number data into the ID table 59. The data stored in each row of the ID table 59 shown in FIG. 2 is the self ID number data and reference ID number data stored in (the memory circuit of) each RFID tag.

Next, the information processing unit 51 sets “0” in all rows of the link flag setting region 67 and checks whether a value of the reference ID number data in the M-th row of the ID table 59 is equal to a value of the self ID number data in the N-th row of the ID table 59. If it is determined, as a result of the check, that both are equal, then “1” is set in the N-th row of the link flag setting region 67. The information processing unit 51 repeats the above processing operations in all rows that constitute the ID table 59.

If, after the above processing operations are repeated, it can be verified that “1” is set in all rows of the link flag setting region 67, then the RFID tags that are linked to each other, in their entirety, form a rotation structure, thus causing the information processing unit 51 to determine that the data of all the RFID tags are read out.

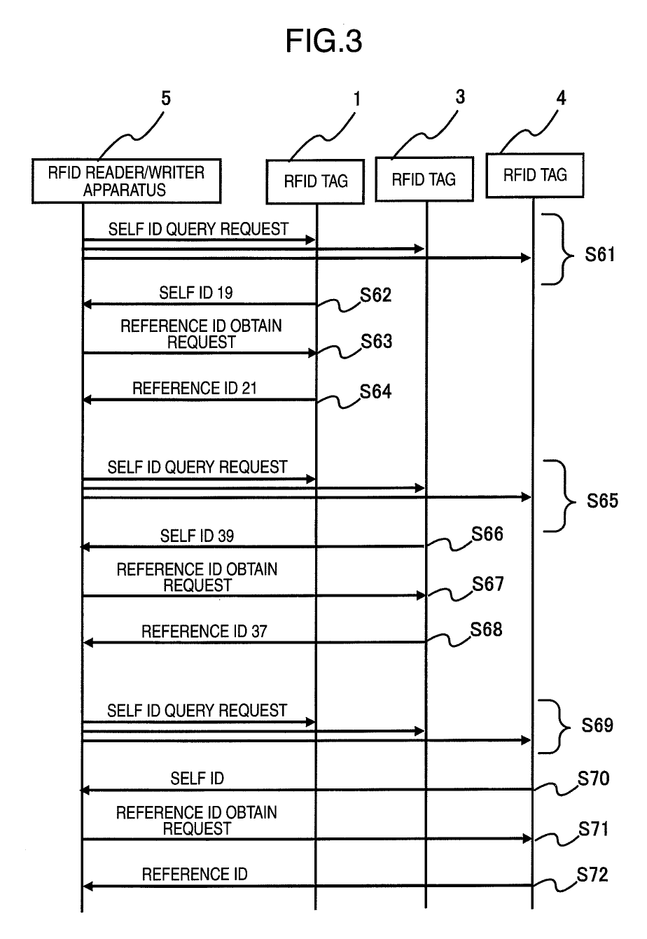

FIG. 3 is an explanatory diagram showing an example of a reading sequence of the self ID number data and reference ID number data that are stored in (the memory circuit of) the RFID tag, which is performed by the RFID reader/writer apparatus 5 shown in FIG. 1

In the sequence diagram of FIG. 3, description is made assuming that another one of the RFID tag also communicates with the RFID reader/writer apparatus 5, in addition to the two FRID tags shown by reference numerals 1, 3 in FIG. 1. A reference numeral 4 is assigned to the additional one of the RFID tag.

In FIG. 3, in the first place, the RFID reader/writer apparatus 5 issues a query request to each of the RFID tags 1, 3, and 4 about the self ID number data assigned to each of the RFID tags 1, 3, and 4 (step S61). If, in response to the query request, self ID number data 19 of the RFID tag 1 is transmitted from the RFID tag 1, then the RFID reader/writer apparatus 5 receives the self ID number data 19 (step S62). In the second place, the RFID reader/writer apparatus 5 issues a request to the RFID tag 1 to obtain reference ID number data (step S63). If, in response to the request, reference ID number data 21 is transmitted from the RFID tag 1, then the RFID reader/writer apparatus 5 receives the reference ID number data 21 (step S64).

Next, the RFID reader/writer apparatus 5 issues a query request again to each of the REID tags 1, 3, and 4 about the self ID number data (step S65). If, in response the query request, self ID number data 39 of the RFID tag 3 is transmitted from the RFID tag 3, then the RFID reader/writer apparatus 5 receives the self ID number data 39 (step S66). Then, the RFID reader/writer apparatus 5 issues a request to the RFID tag 3 to obtain reference ID number data (step S67). If, in response to the request, reference ID number data 37 is transmitted from the RFID tag 3, then the RFID reader/writer apparatus 5 receives the reference ID number 37 (step S68).

Next, the RFID reader/writer apparatus 5 issues a query request again to each of the REID tags 1, 3, and 4 about the self ID number data (step S69). If, in response the query request, self ID number data of the RFID tag 4 is transmitted from the RFID tag 4, then the RFID reader/writer apparatus 5 receives the self ID number data (step S70). Next, the RFID reader/writer apparatus 5 issues a request to the RFID 4 to obtain reference ID number data (step S71). If, in response to the request, reference ID number data is transmitted from the RFID tag 4, then the RFID reader/writer apparatus 5 receives the reference ID number (step S72).

The sequence processing shown in FIG. 3 is performed, and thereby the self ID number data and reference ID number data, which are read out from each of the RFID tags 1, 3, and 4, are written by the information processing unit 51 into the ID table 59 that is set in the information storage unit 55 of the RFID reader/writer apparatus 5 according to, for example, an aspect shown in FIG. 2.

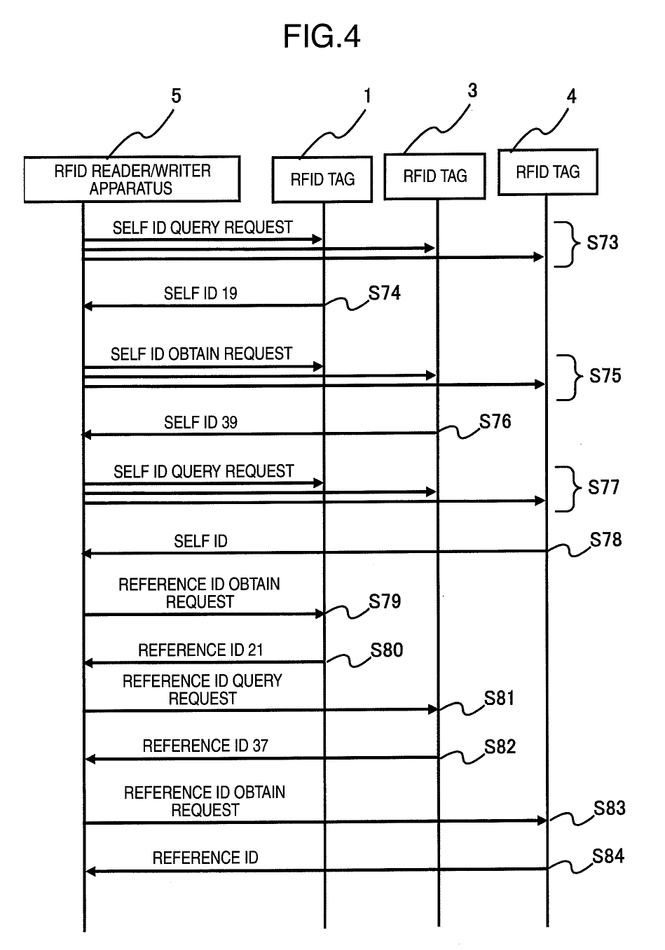

FIG. 4 is an explanatory diagram showing another example of reading sequence of the self ID number data and reference ID number data stored in (the memory circuit) of the RFID tag, which is performed by the RFID reader/writer apparatus 5.

In FIG. 4, in the first place, the RFID reader/writer apparatus 5 issues a query request to each of the RFID tags 1, 3, and 4 about the self ID number data (step S73). If, in response to the query request, the self ID number data 19 of the RFID tag 1 is transmitted from the RFID tag 1, then the RFID reader/writer apparatus 5 receives the self ID number data 19 (step S74). Next, the RFID reader/writer apparatus 5 issues again a query request to each of the RFID tags 1, 3, and 4 about the self ID number data (step S75). If, in response to the query request, the self ID number data 39 of the RFID tag 3 is transmitted from the RFID tag 3, then the RFID reader/writer apparatus 5 receives the self ID number data 39 (step S76). Next, the RFID reader/writer apparatus 5 issues again a query request to each of the RFID tags 1, 3, and 4 about the self ID number data (step S77).

If, in response to the query request, the self ID number data of the RFID tag 4 is transmitted from the RFID tag 4, then the RFID reader/writer apparatus 5 receives the self ID number data (step S78). Next, the RFID reader/writer apparatus 5 issues an request to the RFID tag 1 to obtain reference ID number data (step S79). If, in response to the obtain request, the reference ID number data 21 is transmitted from the RRID tag 1, the RFID reader/writer apparatus 5 receives the reference ID number data 21 (step S80). Next, the RFID reader/writer apparatus 5 issues an request to the RFID tag 3 to obtain reference ID number data (step S81). If, in response to the obtain request, the reference ID number data 37 is transmitted from the RRID tag 3, then the RFID reader/writer apparatus 5 receives the reference ID number data 37 (step S82).

Next, the RFID reader/writer apparatus 5 issues an request to the RFID tag 4 to obtain reference ID number data (step S83). If, in response to the obtain request, reference ID number data is transmitted from the RRID tag 4, then the RFID reader/writer apparatus 5 receives the reference ID number data (step S84).

The sequence processing shown in FIG. 4 is performed, and thereby, as with the case in which the sequence processing shown in FIG. 3 is performed, the self ID number data and reference ID number data, which are read out from each of the RFID tags 1, 3, and 4, are written by the information processing unit 51 into the ID table 59 that is set in the information storage unit 55 of the RFID reader/writer apparatus 5 according to, for example, an aspect shown in FIG. 2.

It should be noted that an anti-collision function, such as a bit collision method and a time slot method, is used, when the RFID reader/writer apparatus 5 receives the self ID number data from each of the RFID tags 1, 3, and 4 by issuing a query request to each of the RFID tags 1, 3, and 4 about the self ID number data in FIG. 3 and FIG. 4,

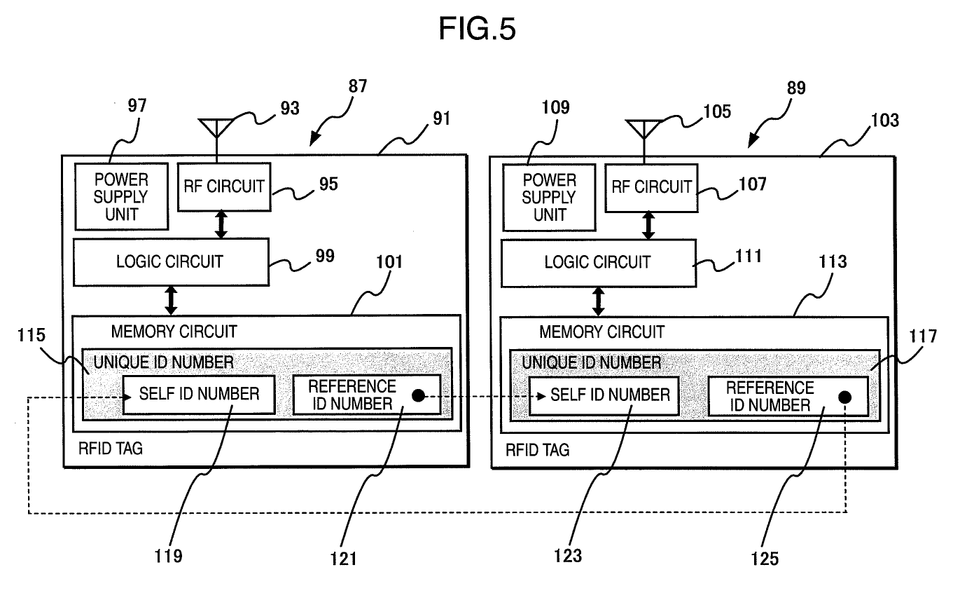

FIG. 5 is an explanatory diagram showing an example of the variation of the RFID tags used in an information management system according to one embodiment of the present invention.

RFID tags 87, 89 shown in FIG. 5 have the same configuration as those 1, 3 shown in FIG. 1. More specifically, the RFID tag 87 comprises an RFID tag body 91; an antenna 93 that is installed at an appropriate place outside the RFID body 91; an RF circuit 95 that is embedded in the RFID tag body 91; a power supply unit 97; a logic circuit 99; and a memory circuit 101. The RFID tag 89, as is the case with the RFID tag 87, also comprises an RFID tag body 103; an antenna 105 that is installed at an appropriate place outside the RFID body 103; an RF circuit 107 that is embedded in the RFID tag body 103; a power supply body 109; a logic circuit 111; and a memory circuit 113.

Each portion that constitutes the RFID tags 87, 89, described above, has the same configuration as each portion that constitutes the RFID tags 1, 3 shown in FIG. 1. Therefore, a detailed description thereof will be omitted here.

As is clear from reference to FIG. 5, the present variation example is characterized in that unique ID number data 115, and unique ID number data 117 are stored in a memory circuit 101 of the RFID tag 87 and a memory circuit 113 of the RFID tag 89, respectively. Here, the unique ID number data is generated by integrating the self ID number data and reference ID number data, and the unique ID number data allows (the information processing unit 51) to identify individual RFID tags in a unique way. The unique ID number data 115 is generated by integrating self ID number data 119 and reference ID number data 121. Similarly, the unique ID number data 117 is generated by integrating self ID number data 123 and reference ID number data 125.

As is clear from reference to FIG. 5, the self ID number data 119 (of the RFID tag 87 side) is stored as the reference ID number data 125 (in the RFID tag 89 side). Similarly, the self ID number data 123 (of the self RFID tag 89 side) is stored as the reference ID number data 121 (in the RFID tag 87 side). It should be noted that while the unique ID number data includes the self ID data and reference ID number data, as described above, it could include information other than the self ID number data and reference ID number data.

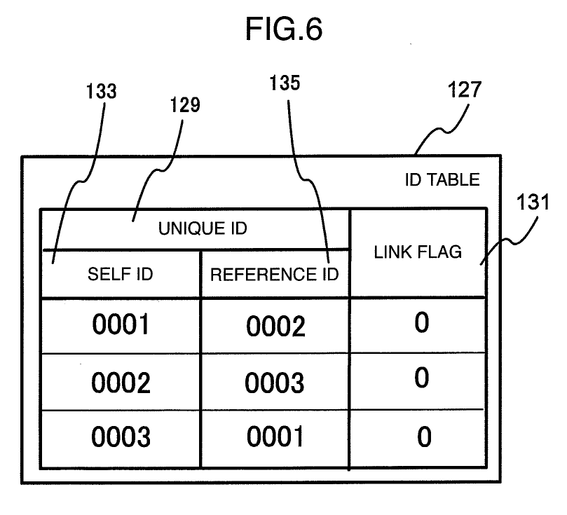

FIG. 6 is an explanatory diagram showing an example of the internal configuration of an ID table which is set in an information storage unit of the RFID reader/writer apparatus which is used for communication with the RFID tags illustrated in FIG. 5.

As FIG. 6 shows, the ID table 127 comprises a unique ID number data storage region 129 and a link flag setting region 131, with the unique ID number data storage region 129 being divided into a self ID number data storage region 133 and a reference ID number data storage region 135. In the self ID number data storage region 133 and reference ID number data storage region 135, self ID number data and reference ID number data, as described above, are stored, respectively. In the example shown in FIG. 6, it is evident that there is a link between an RFID tag with a self ID number of “0001” and an RFID tag with a self ID number of “0002”, a link between the RFID tag with the self ID number of “0002” and an RFID tag with a self ID number of “0003”, and a link between the RFID tag with the self ID number of “0003” and the RFID tag with the self ID number of RFID tag “0001”. Moreover, in the example shown in FIG. 6, “0” is set in any place in a link flag setting region 131 that corresponds to each of the above self ID number data storage region and reference ID number data storage region.

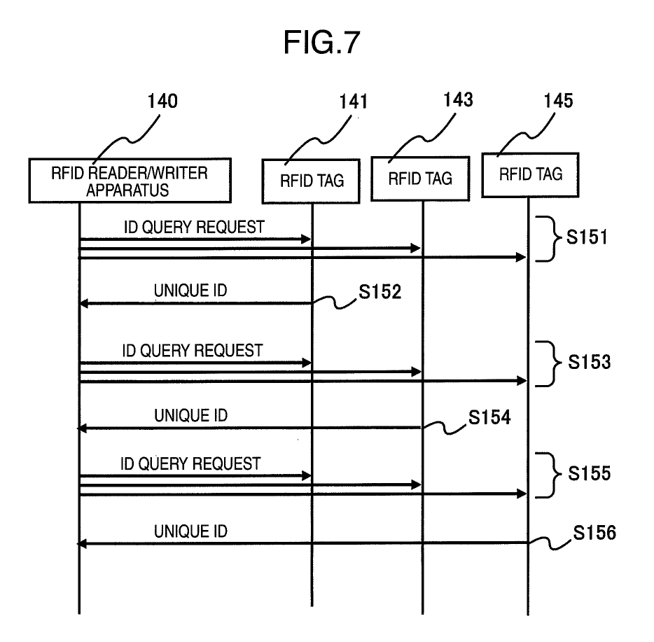

FIG. 7 is an explanatory diagram showing an example of a reading sequence of unique ID number data (stored in the memory circuit of the RFID tag) when the RFID tags (87, 89) shown in FIG. 5 are used in an information management system according to one embodiment of the present invention.

It is assumed that unique ID number data configured as described above are stored in each memory of RFID tags 141, 143, and 145 shown in FIG. 7.

In FIG. 7, in the first place, an RFID reader/writer apparatus 140 issues a query request to the RFID tags 141, 143, and 145 about unique ID number data (step S151). If, in response to the query request, unique ID number data is transmitted from the RFID tag 141, then the RFID reader/writer apparatus 140 receives the unique ID number data (step S152). Second, the RFID reader/writer apparatus 140 issues again a query request to the RFID tags 141, 143, and 145 about the unique ID number data (step S153).

If, in response to the query request, unique ID number data is transmitted from the RFID tag 143, then the RFID reader/writer apparatus 140 receives the unique ID number data (step S154). Next, the RFID reader/writer apparatus 140 issues again a query request to the RFID tags 141, 143, and 145 about the unique ID number data (step S155). If, in response to the query request, unique ID number data is transmitted from the RFID tag 145, then the RFID reader/writer apparatus 140 receives the unique ID number data (step S156).

Through the execution of the sequence processing shown in FIG. 7, the unique ID number data (including the self ID number data and reference ID number data) that is read out from the RFID tags 141, 143, and 145 is written into the ID table 127, which is set in the information storage unit, by the information processing unit in the RFID reader/writer apparatus 140 according to, for example, the aspect shown in FIG. 6.

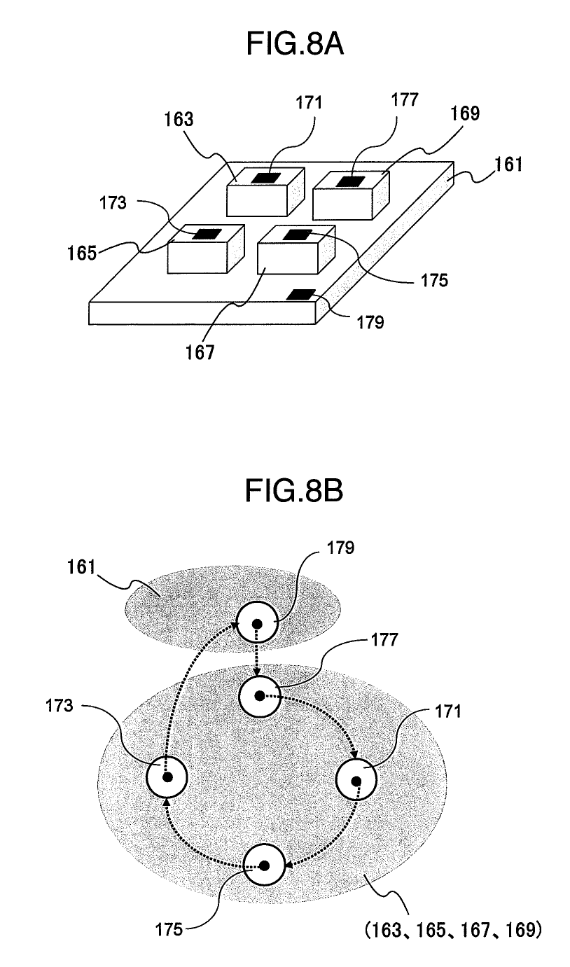

FIGS. 8A and 8B are explanatory diagrams showing an example of various kinds of devices that are required for a distribution process, including handling, transporting and storing of articles in which the RFID tags according to one embodiment of the present invention is employed.

In FIGS. 8A and 8B, a pallet is taken as an example of a device required for the distribution process, including handling, transporting, and storing of articles. Here, the pallet refers to a cargo-handling stage that comprises a surface on which articles that are packaged into unit quantities are placed, forklift entries, and the like in order to handle, transport, and store the articles. In FIG. 8A, a plurality of (four in FIG. 8A) articles 163, 165, 167, and 169 are placed on the placement surface of the pallet 161, and RFID tags 171, 173, 175, and 177 are attached to the top surfaces of the articles 163, 165, 167, and 177, respectively. An RFID tag 179 is also attached to an appropriate place (corner part) of the placement surface of the pallet 161.

Links, for example, such as ones shown in FIG. 8B, are formed among the respective RFID tags (171 to 177) themselves of the articles (163 to 169), and between the RFID tags (171 to 177) and RFID tags 179 of the pallet 161, via the self ID number data and reference ID number data that are stored in the memory circuit of each RFID tag.

More specifically, the RFID tag 179 on the pallet 161 is linked to the RFID tag 177 (on the article 169) (via the self ID number data and reference ID number data that are stored in the memory circuit of each RFID tag). The RFID tag 177 (on the article 169) is also linked to the RFID tag 171 (on the article 163) (via the self ID number data and reference ID number data that are stored in the memory circuit of each RFID tag). The RFID tag 171 (on the article 163) is also linked to the RFID tag 175 (on the article 167) (via the self ID number data and reference ID number data that are stored in the memory circuit of each RFID tag). The RFID tag 175 (on the article 167) is also linked to the RFID tag 173 (on the article 165) (via the self ID number data and reference ID number data that are stored in the memory circuit of each RFID tag). Furthermore, the RFID tag 173 (on the article 165) is linked to the RFID tag 179 on the pallet 161 (via the self ID number data and reference ID number data that are stored in the memory circuit of each RFID tag).

Which one of the RFID tags (171 to 179) is attached to the pallet 161, and which RFID tag is attached to which article (of the articles 163 to 169) can be identified by the RFID reader/writer apparatus through the use of an ID number data system (such as the self ID number data, and reference ID number data), or additional information that is stored in (the memory circuit of) each RFID tag.

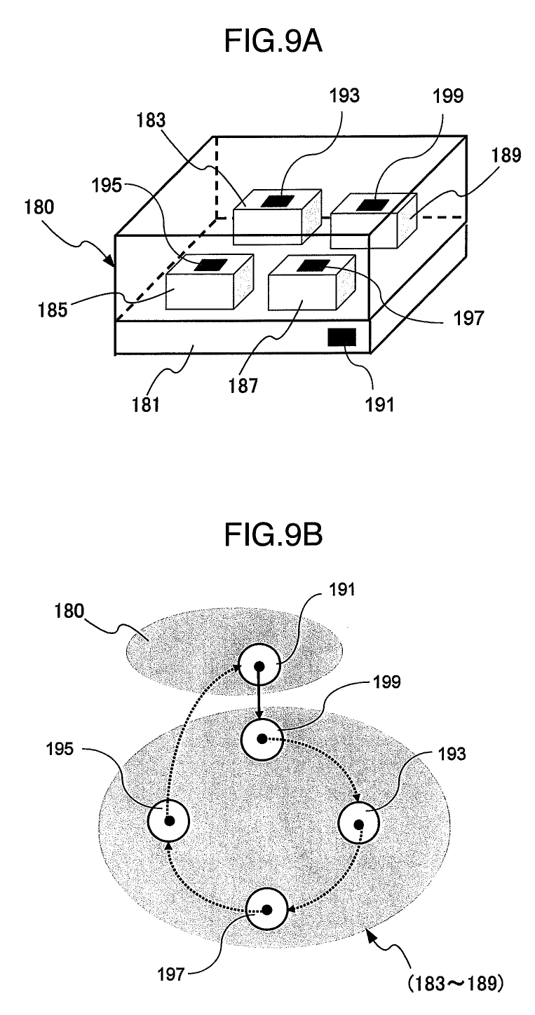

FIGS. 9A and 9B are explanatory diagrams showing an example of a package of an industrial product that is finished (referred to as “a finished product” hereinafter), as an article in which the RFID tag according to one embodiment of the present invention is employed, and attachments that are used together with the finished product.

In FIG. 9A, an RFID tag 191 is attached to an appropriate place (lower right corner of the front) of the outer surface of the package 180 that packages the finished product 181 and attachments 183 to 189. RFID tags 193, 195, 197, and 199 are attached to the upper surfaces of the attachments 183, 185, 187, and 189, respectively.

Links, for example, such as ones shown in FIG. 9B, are formed between the RFID tag 191 of the package 180 side and any of the RFID tags (193 to 199) of attachments (183 to 189) side, and between the RFID tags (193 to 199) themselves of the attachments (183 to 189) via the above described self ID number data and reference ID number data that are stored in the memory circuit of each FRID tag (191 to 199).

More specifically, the RFID tag 191 of the package 180 side is linked to the RFID tag 199 (on the attachment 189) (via the self ID number data and reference ID number data that are stored in the memory circuit of each RFID tag). The RFID tag 199 (on the attachment 189) is linked to the RFID tag 193 (on the attachment 183) (via the self ID number data and reference ID number data that are stored in the memory circuit of each RFID tag).

The RFID tag 193 (on the attachment 183) is also linked to the RFID tag 197 (on the attachment 187) (via the self ID number data and reference ID number data that are stored in the memory circuit of each RFID tag). The RFID tag 197 (on the attachment 187) is also linked to the RFID tag 195 (on the attachment 185) (via the self ID number data and reference ID number data that are stored in the memory circuit of each RFID tag). Furthermore, the RFID tag 195 (on the attachment 185) is linked to the RFID tag 191 of the package 180 side (via the self ID number data and reference ID number data that are stored in the memory circuit of each RFID tag).

In the above-described aspect, an RFID tag is attached to an appropriate place of the outer surface of the package 180 that packages the finished product 181 and attachments 183 to 189, and the RFID tags are also attached to appropriate places of respective attachments 183 to 189. Then, the above described self ID number data, reference ID number data, and the like that are stored in (the memory circuits of) the RFID tags are configured to be read and checked through the RFID reader/writer apparatus. Therefore, even if there occurs an event in which the attachments packaged with the finished product are extracted or replaced in an unauthorized manner, it can be rapidly detected through the RFID reader/writer apparatus, thus making it possible to take an appropriate countermeasure.

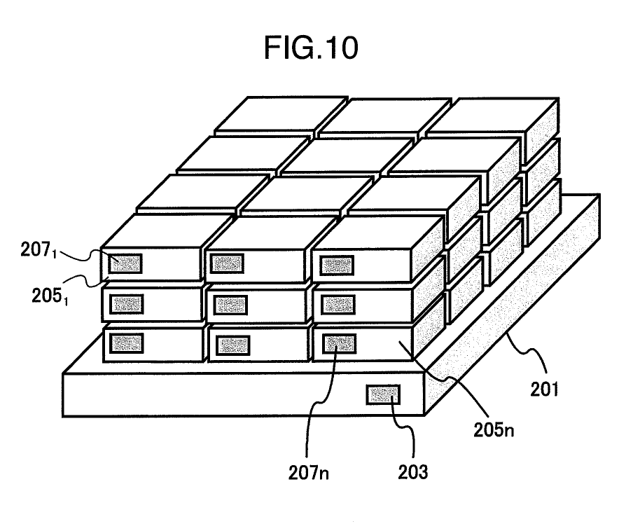

FIG. 10 is an explanatory diagram showing another example of various kinds of devices required for an article distribution process that includes handling, transporting, and storing of articles in which tags according to one embodiment of the present invention are employed.

In FIG. 10, a pallet is taken as a device required for the article distribution process that includes handling, transporting, and storing of articles. In addition, a plurality of articles that are each packed (hereinafter referred to as “individual articles”) are taken as the articles that are placed on the pallet.

In FIG. 10, a plurality (although 36 articles are shown in total in FIG. 10, n is used for the total number here for the sake of description) of individual articles 205₁ to 205ₙ are placed on the placement surface of the pallet 201. A plurality of RFID tags (hereinafter referred to as “individual article tags”) 207₁ to 207ₙ are attached to the front of the individual articles 205₁ to 205ₙ, respectively. Similarly, an RFID tag (hereinafter referred to as “a package tag”) 203 is also attached to an appropriate place (right corner part here) on the front of the pallet 201.

The self ID number data and reference ID number data, as described above, are stored in (a memory circuit of) each of the individual article tags 207₁ to 207ₙ. Moreover, link multiplicity data, circulation structure formation flag data, individual article tag total data, and update link information are stored in (a memory circuit of) the package tag 203 in addition to the above self ID number data and reference ID number data.

The link multiplicity data in the above respective data and information, which are stored in the package tag 203, refers to the data that indicates the multiplicity of the link formed between respective individual tags (207₁ to 207ₙ) (via the self ID number data and reference ID number data that are stored in each memory circuit). In the above link multiplicity data, a multiplicity “0” indicates a state in which a link is not formed between any of the individual article tags (207₁ to 207ₙ). In other words, it indicates that the above described reference ID number data is not stored in any individual article tags (207₁ to 207ₙ). Next, a multiplicity “1” indicates a state in which one link is formed between each of the individual article tags (207₁ to 207ₙ) (via the self ID number data and reference ID number data that are stored in each memory circuit). In other words, it indicates that one piece each of the above described reference ID number data is stored in each of the individual article tags (207₁ to 207ₙ).

Next, a multiplicity “2” indicates a state in which two links are formed between each of the individual package tags (207₁ to 207ₙ) (via the self ID number data and reference ID number data that are stored in each memory circuit). In other words, it indicates that two pieces each of the above described reference ID number data are stored in each of the individual article tags (207₁ to 207ₙ). In addition, a multiplicity “3” indicates a state in which three links are formed between each of the individual article tags (207₁ to 207ₙ) (via the self ID number data and reference ID number data that are stored in each memory circuit). In other words, it indicates that three pieces each of the above described reference ID number data are stored in each of the individual article tags (207₁ to 207ₙ). The state in which two or more pieces of reference ID number data are stored in each of the individual article tags (207₁ to 207ₙ) as described above is referred to as a multiple state of link that is defined in one embodiment of the present invention.

The circulation structure formation flag data refers to flag (data) that indicates whether links formed (in one layer or a multiple state) via the self ID number data and reference ID number data that are stored in each of the individual article tags (207₁ to 207ₙ) establish a circulation structure, in their entirety. The individual article tag total number data refers to the data that indicates the total number of the individual article tags (207₁ to 207ₙ) each attached to each of the individual articles (205₁ to 205ₙ). The update link information refers to the information related to the individual article tags (that are attached to removed individual articles), which lost a link that has been formed until the time when, for example, any of the above individual articles (205₁ to 205ₙ) is removed from the pallet 201. The information related to the individual article tags refers to the self ID number data and reference ID number data of the individual article tags.

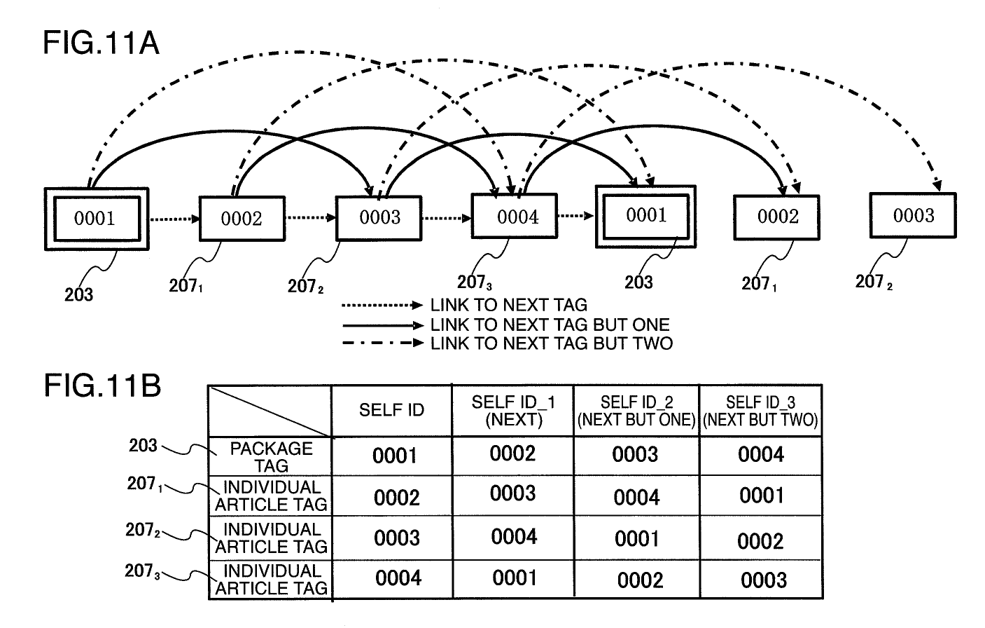

FIGS. 11A and 11B are explanatory diagrams showing multiple links formed between the package tag and individual article tags, and between the individual article tags themselves, via the self ID number data and reference ID number data that are stored in (the memory circuits of) the above package tag, and via the self ID number data and reference ID number data that are stored in (the memory circuit of) each of the above plurality of individual tags.

In an example shown in FIGS. 11A and 11B, “0001”, “0002”, “0003”, and “0004” are previously assigned to (a memory circuit of) a package tag 203, (a memory circuit of) a package tag 207₁, (a memory circuit of) a package tag 207₂, and (a memory circuit of) a package tag 207₃, respectively, as self ID number data. In addition, three-way links are established among the package tag 203, and individual article tags 207₁, 297₂, and 207₃ via the self ID number data and reference ID number data that are stored in (the memory of) each tag.

In other words, as FIG. 11A shows, the package tag 203 forms links with the individual article tag 207₁ with the next self ID number data, individual article tag 207₂ with the next self ID number data but one, and individual article tag 207₃ with the next self ID number data but two. Next, the individual article tag 207₁ forms links with the individual article tag 207₂ with the next self ID number data, individual article tag 207₃ with the next self ID number data but one, package tag 203 with the preceding self ID number data. The individual article tag 207₂ forms links with the individual article tag 207₃ with next self ID number data, package tag 203 with the preceding self ID number data but one, individual article tag 207₁ with the preceding self ID number data. Moreover, the package 207₃ forms links with the package tag 203 with the preceding self ID number data but two, individual article tag 207₁ with the preceding self ID number data tag but one, individual article tag 207₂ with the preceding self ID number data.

Data (self ID number data and reference ID number data), such as shown in FIG. 11B, are stored in the memory circuit of each of the package tag 203, and individual article tags 207₁, 207₂, and 207₃ to ensure that the three-way links are formed among the package tag 203, and individual article tags 207₁, 207₂, and 207₃ via the self ID number data and reference ID number data as described above. In other words, in the memory circuit of the package tag 203, as self ID number data, “0001” is stored, and as the reference ID number data, “0002” which is the self ID number data for the individual article tag 207₁ with the next self ID number data, “0003” which is the self ID number data for the individual article tag 207₂ with the next self ID number data but one, and “0004” which is the self ID number data for the individual article tag 207₃ with the next self ID number data but two are stored.

Next, in a memory circuit of the individual article tag 207₁, as the self ID number data, “0002” is stored, and as the reference ID number data, “0003” which is the self ID number data for the individual article tag 207₂ with the next self ID number data, “0004” which is the self ID number data for the individual article tag 207₃ with the next self ID number data but one, and “0001” which is the self ID number data for the package tag 203 with the preceding self ID number data are stored.

Similarly, in a memory circuit of the individual article tag 207₂, as the self ID number data, “0003” is stored, and as the reference ID number data, “0004” which is the self ID number data for the individual article tag 207₃ with the next self ID number data, “0001” which is the self ID number data for the package tag 203 with the preceding self ID number data but one, and “0002” which is the self ID number data for the individual article tag 207₁ with the preceding self ID number data are stored.

Furthermore, in a memory circuit of the individual article tag 207₃, as the self ID number data, “0004” is stored, and as the reference ID number data, “0001” which is the self ID number data for the package tag 203 with the preceding self ID number data but two, “0002” which is the self ID number data for the individual article tag 207₁ with the preceding self ID number data but one, and “0003” which is the self ID number data for the self ID number data 207₂ with the preceding self ID number data are stored.

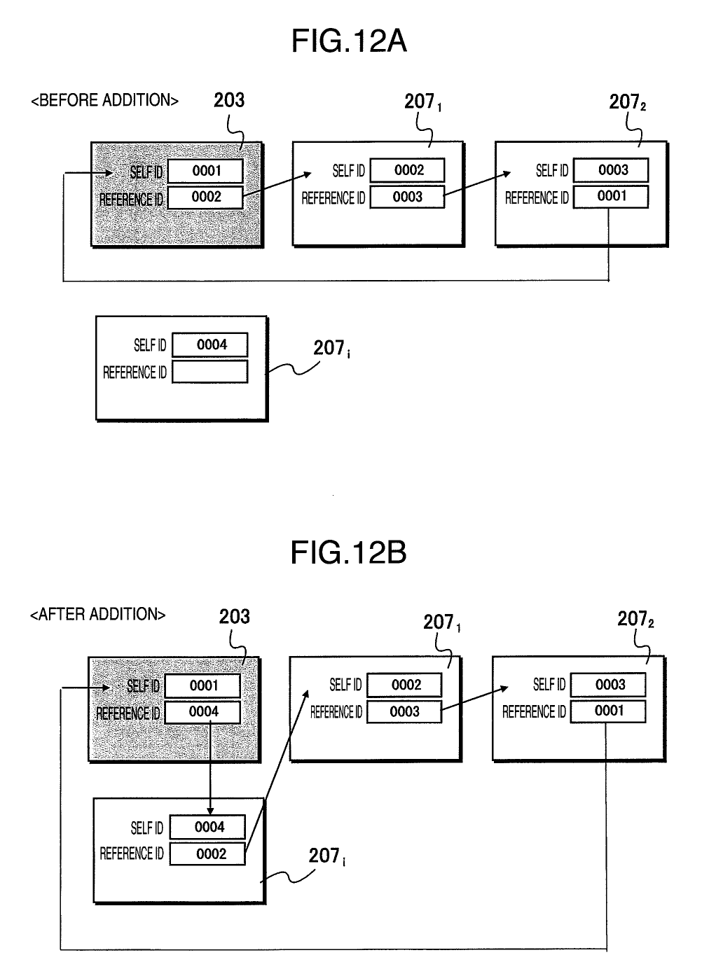

FIGS. 12A and 12B are schematic diagrams showing a process when an individual article is additionally loaded on the pallet in the aspect shown in FIG. 10, and when a link is formed between the individual article tag of the individual article that is additionally loaded and the existing package tag and individual article tags via the self ID number data and reference ID number data that are stored in (the memory circuit of) each tag.

FIG. 12A shows a relationship between the individual article tag of the new individual article and the existing package tag and individual article tags before the new individual article is additionally loaded on the pallet. In FIG. 12A, in (the memory circuit of) the package tag 203, “0001” is stored as self ID number data, and “0002” is stored as reference ID number data. Similarly, in (the memory circuit of) the individual article tag 207₁, “0002” and “0003” are stored as self ID number data and reference ID number data, respectively. In (the memory circuit of) the individual article tag 207₂, “0003” and “0001” are stored as self ID number data and reference Id number data, respectively. Furthermore, in (the memory circuit of) the individual article tag 207ᵢ of the new individual article, “0004” is stored as self ID number data, and none is stored as reference ID number data.

Therefore, while links are formed between the package tag 203 and individual tag 207₁, between the individual tag 207₁ and individual tag 207₂, and between the individual tag 207₂ and package tag 203, no link is formed between the individual article tag 207ᵢ and package tag 203, and between the individual article tag 207ᵢ and individual article tag (any one of 207₁ and 207₂).

FIG. 12B shows a relationship between the individual article tag of the new individual article and existing package tag and individual article tags after the new individual article is additionally loaded on the pallet. In FIG. 12B, in (the memory circuit of) the individual article tag 207ᵢ, “0002” is written as the reference ID data, and in (the memory circuit of) the package tag 203, the reference ID number data is rewritten from “0002” to “0004”.

Accordingly, links are formed between the package tag 203 and new individual article tag 207ᵢ, between the new individual article tag 207ᵢ and individual article tag 207₁, between the individual article tag 207₁ and individual article tag 207₂, and between the individual article tag 207₂ and package tag 203.

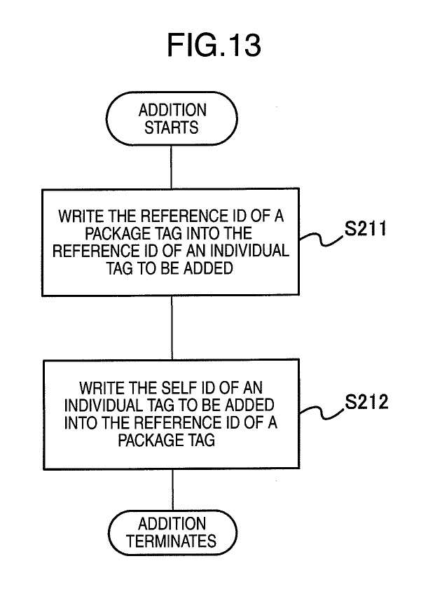

FIG. 13 is a flow chart showing a processing procedure when the new individual article is additionally loaded on the pallet and thereby links are formed between the individual article tag of the new individual article and existing package tag and individual article tags via the self ID number data and reference ID number data that are stored in (the memory circuit of) each tag.

In FIG. 13, in the first place, “0002”, which is the reference ID number data stored in (the memory circuit) of the package tag 203, is written into (the memory circuit of) the new individual article tag 207ᵢ by the RFID reader/writer apparatus (step S211). In the second place, “0004”, which is the self ID number data of the above new individual article tag 207ᵢ, is written into (the memory circuit of) the package tag 203 (step S212).

Through the execution of the processing operations represented by the above two steps, links shown in FIG. 12B are newly formed between the new individual article tag and existing package tag and, between the new individual article tag and existing individual article tags (via the self ID number data and reference ID number data that are stored in each memory circuit).

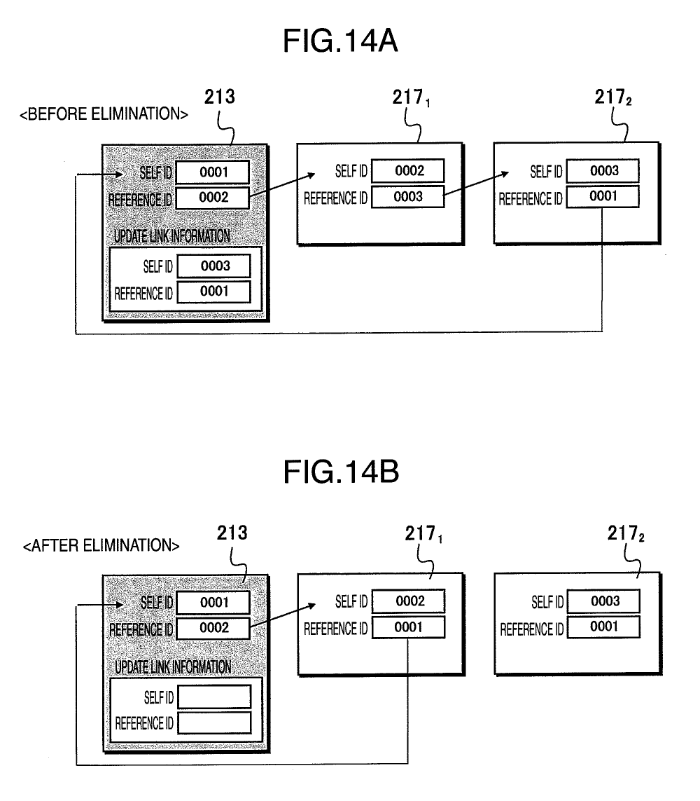

FIGS. 14A and 14B are schematic diagrams showing a process when, in the aspect shown in FIG. 10, any individual article is removed from the individual articles that have been loaded on the pallet, and when links are formed between the individual article tags themselves of remaining individual articles, and between those individual tags and package tag via the self ID number data and reference ID number data that are stored in (the memory circuit of) each tag.

FIG. 14A shows links that are formed between the package tag and individual article tags, and between individual article tags themselves, before any individual article is eliminated from the pallet, via the self ID number data and reference ID number data that are stored in (the memory circuit of) each tag.

In FIG. 14A, in (the memory circuit of) the package tag 213, not only “0001” as the self ID number data and “0002” as the reference ID number data are stored, but also self ID number data “0003”, and reference ID number data “0001” for the individual article tag 217₂, which is going to be eliminated, are stored as update link information. Moreover, in (the memory circuit of) of an individual tag 217₁, “0002” and “0003” are stored as the self ID number data and reference ID number data, respectively. In (the memory circuit of) of an individual tag 217₂, “0003” and “0001” are stored as the self ID number data and reference ID number data, respectively.

In other words, links are formed between the package tag 213 and individual article tag 217₁, between the individual article tag 217₁ and individual article tag 217₂, and between the individual article tag 217₂ and package tag 213 (via the self ID number data and reference ID number data that are stored in (the memory circuit of) each tag).

FIG. 14B shows links that are formed between the package tag and individual tags, and between the individual article tags themselves via the self ID number data and reference ID number data that are stored in (the memory circuit of) each tag, after any individual article is eliminated from the pallet. In FIG. 14B, the self ID number data and reference ID number data (of the individual article tag 217₂), which are stored as the update link information, are removed from (the memory circuit of) the package tag 213, and the self ID number data “0003” (of the individual tag 217₂), which is stored in (the memory circuit of) the individual article tag 217₁, is rewritten into self ID number data “0001” (of the package tag 213) by the RFID reader/writer apparatus. This causes the links between the individual article tag 217₁ and individual article tag 217₂, and between the individual article tag 217₂ and package tag 213 to be both cancelled, resulting in the formation of a link only between the package tag 213 and individual article tag 217₁.

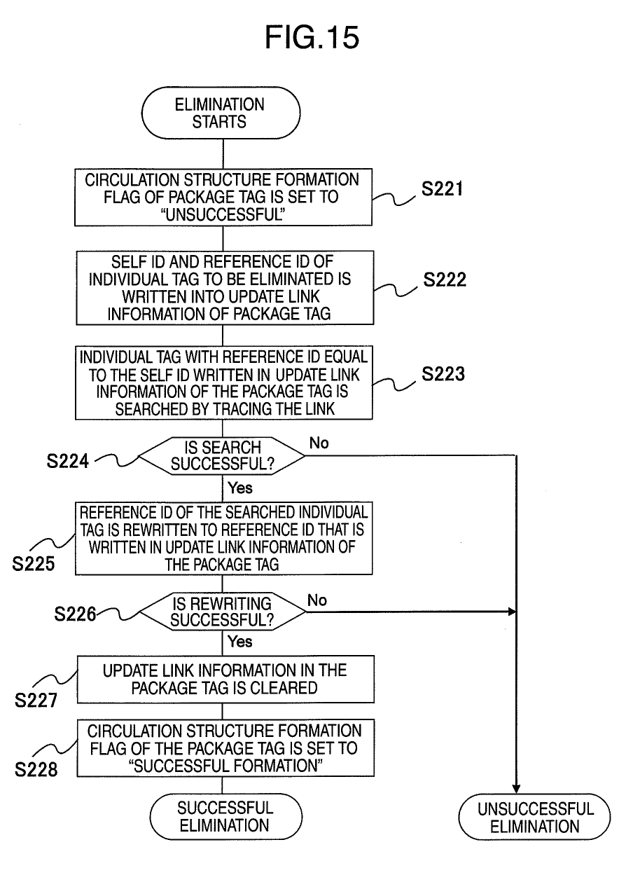

FIG. 15 is a flow chart showing a processing procedure when, after any individual article is removed from the pallet, links are formed between the individual article tags themselves of remaining individual articles, and between those individual article tags and package tag via the self ID number data and reference ID number data that are stored in (the memory circuit of) each tag.

In FIG. 15, in the first place, the circulation structure formation flag data that is held in (the memory circuit of) the package tag 213 is rewritten from “formed” (for example, “1”) to “not formed” (for example, “0”) by the RFID reader/writer apparatus (step S221). In the second place, the self ID number data and reference ID number data that are stored in (the memory circuit of) the individual article tag (217₂), which is to be removed, are written into (the memory circuit of) the package tag 213 as update link information by the RFID reader/writer apparatus (step S222).

Next, the RFID reader/writer apparatus searches an individual article tag (individual tag 217₁ in this case), in which the self ID number data (“0003”) is stored as the reference ID number data, by tracing the existing link. The self ID number data (“0003”) is written in (the memory circuit of) the package tag 213 as the above update link information (step S223). It is checked whether the above search was successful (step S224). If it is determined, as a result of the check, that the search was successful (YES at the step S224), then the RFID reader/writer apparatus rewrites the reference ID number data (“0003” in this case) stored in (the memory circuit of) the searched individual article tag (individual article tag 217₁ in this case) into the reference ID number data (“0001” in this case) written in (the memory circuit of) the package tag 213 as the update link information (step S225).

Then, it is checked whether the rewrite was successful or not (step S226). If it is determined, as a result of the check, that the rewrite was successful (YES in step S226), then the RFID reader/writer apparatus erases both the self ID number data (“0003”) and reference ID number data (“0001”) that are written in (the memory circuit of) the package tag 213 as the update link information (step S 227). Next, the RFID reader/writer apparatus rewrites the circulation structure formation flag data held in (the memory circuit of) the package tag 213 from “not formed” (for example “0”) to “formed” (for example, “1”), and a series of processing operations are completed (step S228).

If it is determined, as a result of the check at step S224, that the search was unsuccessful (NO at step S224), and if it is determined, as a result of the check at step S226, that the rewrite was unsuccessful (NO at step S226), then the series of processing operations are suspended at that point.

Even if it was unsuccessful to eliminate the self ID number data (“0003”), and reference ID number data (“0001”) of the individual article tag of the individual article that was removed from the pallet from (the memory circuit of) the remaining individual article tag (individual article tag 217₁ in this case) the execution of the processing operations shown in FIG. 15 would enable the elimination processing to be performed again at a later time, since the above described update link information is written in (the memory circuit of) the package tag 203.

While the preferred embodiments according to the present invention and examples of the variation have been described in the foregoing, they are just an exemplification for the purpose of describing the present invention. It is not intended to limit the scope of the present invention to the embodiments and samples of the variation. It is to be understood that the present invention can be embodied in other various forms.

1. An IC memory that has an information transmission/reception capability and an information processing capability, and transmits and receives information to and from an external information communication apparatus,
wherein said IC memory stores first identification data for identifying that IC memory, said first identification data being required by a plurality of IC memories to form links between said IC memories themselves on data, and second identification data for identifying an IC memory different from said IC memory, in a memory portion thereof.

2. The IC memory according to claim 1, wherein said first and second identification data are written into said memory portion by said external information communication apparatus.

3. The IC memory according to claim 1, wherein said IC memory stores at least two or more pieces of said second identification data in the memory portion.

4. An information communication apparatus that has an information processing capability, and transmits and receives information to and from the IC memory having an information transmission/reception capability and an information processing capability,
wherein said information communication apparatus stores comprehensive IC memory identifying data that includes at least first identification data for identifying a certain IC memory, said first identification data being required by a plurality of IC memories to form links between said IC memories themselves on data, and second identification data for identifying an IC memory other than said certain IC memory, in a storage unit thereof.

5. The information communication apparatus according to claim 4,
wherein said comprehensive IC memory identifying data is generated based on said first and second identification data that are transmitted from said IC memory.

6. The information communication apparatus according to claim 4,
wherein at least two or more pieces of said second identification data are included in one piece of said comprehensive IC memory identifying data.

7. The information communication apparatus according to claim 4, further comprising
flag data that indicates whether said comprehensive IC memory identifying data is actually forming a link on the data.

8. The information communication apparatus according to claim 7,
wherein said flag data is set to a value indicating that said link is not formed during the generation of said comprehensive IC memory identifying data.

9. An information management system, comprising:
an IC memory that has an information transmission/reception capability and an information processing capability; and
one or a plurality of information communication apparatuses that have an information processing capability, and transmit and receive information to and from said IC memory,
wherein said IC memory stores first identification data for identifying that IC memory, said first identification data being required by a plurality of IC memories to form links between said IC memories themselves on data, and second identification data for identifying an IC memory different from said IC memory, in a memory portion thereof, and
wherein said information communication apparatuses stores comprehensive IC memory identifying data that includes at least first identification data for identifying a certain IC memory, said first identification data being required by a plurality of IC memories to form links between said IC memories themselves on data, and second identification data for identifying an IC memory different from said certain IC memory, in a storage unit thereof.

10. The information management system according to claim 9, comprising:
a placement stage for placing articles thereon,
wherein said information management system is applied to an operation device for performing operations necessary when sending the articles in a distribution process.

11. The information management system according to claim 10,
wherein said information communication apparatus is disposed such that the transmission/reception unit thereof faces said placement stage, and said IC memories are each mounted at an appropriate place of each of the articles loaded on said placement stage.

12. The information management system according to claim 11, wherein the IC memory mounted on said placement stage stores:
first identification data for identifying that IC memory, which is required by said plurality of IC memories to form links between said IC memories themselves on data;
second identification data for identifying an IC memory that is different from said IC memory and is mounted on any of the articles loaded on said placement stage;
data indicating whether said links, in their entirety, form a circulation structure;
multiplicity data indicating how many of said links are formed between said IC memory and a plurality of memories that are different from said IC memory and are mounted on the plurality of articles loaded on said placement stage;
data indicating a total number of the IC memories that are mounted on said each article;
at least said first identification data and second identification data, within update link information, that indicate a change in said links; and
data indicating whether said links, in their entirety, form a circulation structure.

13. The information management system according to claim 12,
wherein each of the comprehensive IC memory identifying data stored by said information communication apparatus includes at least two or more pieces of said second identification data.

14. The information management system according to claim 13, wherein when a communication is established between said information communication apparatus and a new IC memory attached to a new article due to the additional loading of the new article on said placement stage, said information communication apparatus
causes said new IC memory to store data for identifying the IC memory mounted on said placement stage; and
causes the IC memory mounted on said placement stage to store data for identifying said new IC memory.

15. The information management system according to claim 13, wherein when any of a plurality of articles loaded on said placement stage is removed, resulting in a loss of communication between said communication apparatus and an IC memory of said removed article, said communication apparatus
causes the IC memory of said placement stage to store first identification data for identifying the IC memory of said removed article, and second identifying data, which is stored in said IC memory, for identifying another IC memory with which the said IC memory has formed a link on data;
causes an IC memory of another article that stores said first identifying data to store the second identifying data; and
causes subsequently said stored first and second identification data to be erased from the IC memory of said placement stage.

16. The information management system according to claim 15, wherein when communication is lost between said information communication apparatus and the IC memory of the article that was removed from said placement stage, data related to said circulation structure, which is stored in the IC memory of the said stage, is changed to unsuccessful circulation, and after said processing of the IC memory of said placement stage and IC memory of another article loaded on said placement stage is terminated, the data related to said circulation structure is changed to successful circulation.
